(19) United States
(12) Patent Application Publication
(10) Pub. No.: US 2026/0285166 A1
(43) Pub. Date: Sep. 24, 2026

(54) METHOD FOR CONTROLLING AN ELECTRIC DRIVE, CONTROL UNIT AND VEHICLE

(71) Applicant: ZF CV Systems Global GmbH, Bern (CH)

(72) Inventors: Mark Schaper, Hannover (DE); Thomas Kattenberg, Vechelde (DE)

(21) Appl. No.: 19/684,581

(22) Filed: May 21, 2026

Related U.S. Application Data
(63) Continuation of application No. PCT/EP2024/082348, filed on Nov. 14, 2024.

(30) Foreign Application Priority Data
Nov. 21, 2023 (DE) 10 2023 132 373.3

(51) Int. Cl. B60L 15/20

(52) U.S. Cl. CPC B60L 15/2009; B60L 2200/36; B60L 2240/14; B60L 2240/423; B60L 2240/463

(57) ABSTRACT

A method is for controlling an electric drive which is configured to generate a torque on a wheel of an axle of a vehicle. The method includes: receiving a deceleration request signal; analyzing and classifying the deceleration request signal in order to form a classified deceleration request signal; determining a gradient threshold of a torque gradient of the electric drive on the basis of the classified deceleration request signal; and actuating the electric drive using a drive actuation signal in order to generate a negative torque on the wheel of the vehicle axle on the basis of the determined gradient threshold. A control unit for carrying out the method is for a vehicle. A vehicle, in particular a utility vehicle, includes a control unit for carrying out the method.

### CROSS-REFERENCE TO RELATED APPLICATIONS

This application is a continuation application of international patent application PCT/EP2024/082348, filed Nov. 14, 2024, designating the United States and claiming priority from German application 10 2023 132 373.3, filed Nov. 21, 2023, and the entire content of both applications is incorporated herein by reference.

### TECHNICAL FIELD

The disclosure relates to a method for controlling an electric drive configured to generate a torque on a wheel of a vehicle axle of a vehicle. The disclosure further relates to a control unit for a vehicle and to a vehicle, in particular a commercial vehicle, for carrying out the method.

### BACKGROUND

US 2018/0154777 A1 discloses a brake control method and a device therefor, a control unit of the device being configured to receive driving environment information from at least one sensor and to assess an emergency braking requirement. The control unit is also configured to activate a regenerative braking function and a friction braking function to decelerate the vehicle. Furthermore, the control unit is configured to monitor the speed of at least one wheel of the vehicle and to customize the regenerative braking and the friction braking based on the monitored speed.

### SUMMARY

According to an embodiment of the disclosure, a method for controlling an electric drive is proposed, the electric drive being configured to generate a torque on a wheel of a vehicle axle of a vehicle, including the steps of:
receiving a deceleration request signal;
evaluating and classifying the deceleration request signal to produce a classified deceleration request signal;
determining a gradient limit value of a torque gradient of the electric drive on the basis of the classified deceleration request signal; and
actuating the electric drive via a drive control signal to generate a negative torque according to the determined gradient limit value on the wheel of the vehicle axle.

The proposed method can be used to attain dynamic, flexible and situation-appropriate customization of a torque generation on the wheel of the vehicle axle. The proposed method can be used to better align a deceleration effect on a deceleration request signal with an existing driving situation. The deceleration effect can be influenced in favor of component-friendly slowing of the vehicle or in favor of a shortened braking distance of the vehicle, depending on the situation, for example, individual account of the two requirements being able to be taken to different extents depending on the situation.

The electric drive is configured to generate a torque on a wheel of a vehicle axle of a vehicle. The torque can be generated via the electric drive on one or more wheels of one or more vehicle axles, so that the electric drive may be in the form of a single-wheel drive or in the form of a central drive for multiple vehicle axles, for example.

There may also be provision for a common electric drive for each of the wheels of a vehicle axle, so that there is one electric drive per vehicle axle. The electric drive may be configured to be able to generate positive torques and negative torques on the at least one wheel, an acceleration effect being attainable by a positive torque and a deceleration effect being attainable by a negative torque. Controlled acceleration or deceleration is achieved by providing a drive control signal, which the electric drive converts into a torque generation. The drive control signal can be generated by a control unit, for example, which can convert acceleration request signals or deceleration request signals received at an input of the control unit into a corresponding drive control signal at an output of the control unit. If the vehicle has multiple electric drives for the wheels of the vehicle axles, the control unit may be configured to coordinate the drive control signals of the multiple electric drives with one another in such a way that an aligned acceleration or deceleration effect occurs. By way of example, certain driving situations, such as cornering, can be taken as a basis for providing drive control signals for the electric drives that result in different torques on individual wheels of the vehicle axles.

The vehicle may be a commercial vehicle, in particular. By way of example, the commercial vehicle may be a towing vehicle, a trailer vehicle or a vehicle combination including a towing vehicle and a trailer vehicle. The above-described advantages of the method can develop a high optimization potential, in particular for commercial vehicles, since commercial vehicles can often have a higher total mass and thus a higher load on vehicle components compared to passenger vehicles and it may therefore be all the more advantageous to be able to dynamically and flexibly prioritize an increased service life of the drive components of the vehicle or a high deceleration effect. An advantageous use for the method is obtained for a vehicle combination including a towing vehicle, which includes an electric drive for generating a torque on a wheel of a vehicle axle of the towing vehicle, and a trailer vehicle, coupled to the towing vehicle, which includes an electric drive for generating a torque on a wheel of a vehicle axle of the trailer vehicle. This allows the respective deceleration effect of the towing and trailer vehicles to be aligned with one another, so that, for example, the trailer vehicle can be reliably prevented from being pushed into the towing vehicle due to a lower deceleration effect on the trailer vehicle. It is conceivable, for example, for a common drive control signal to be transmitted to the electric drives of the towing vehicle and the trailer vehicle or for a respective individual drive control signal for the electric drive of the towing vehicle and for the electric drive of the trailer vehicle to be generated on the basis of the classified deceleration request signal and the determined gradient limit value, for example in order to be able to take individual account of different vehicle properties. However, it is, for example, also possible, in principle, for use of the method on a vehicle combination, to combine a towing vehicle that includes an internal combustion engine with a trailer vehicle that includes an electric drive or to combine a towing vehicle that includes an electric drive with a non-driven trailer vehicle. According to one configuration option, the trailer vehicle may be in the form of a semi-trailer and the towing vehicle may be in the form of a tractor unit.

A deceleration request signal can be generated on the basis of a current driving situation, for example a braking request signaled by the driver or a dangerous situation detected by the vehicle can be converted into a deceleration request signal. A signal strength, a signal characteristic or a signal type of the deceleration request signal can vary depending on the driving situation. Therefore, the deceleration request signal can be evaluated and classified, for example via the above-described control unit, on the basis of signal properties, for example also on the basis of signal characteristics, so that the classified deceleration request signal can, for example, indicate a particular driving situation.

The generation of the torque on the wheel of the vehicle axle via the electric drive can be carried out according to a torque gradient, for example predetermined by the control systems. A torque gradient can be understood to mean a degree of change in the torque as a function of time, for example a slope of the torque characteristic or, in simplified terms, a speed of the torque increase. Higher torque gradients can be associated with a higher deceleration effect, but due to the configuration circumstances and mode of operation of electric drives they are also associated with a higher component load on the drive than lower torque gradients. It can therefore be technically useful to limit the torque gradient of the electric drive in order to protect the components of the electric drive and, in particular, to prevent them from being damaged due to a very high torque gradient. For this purpose, a gradient limit value can be set, for example, and stored in the control unit, for example. The gradient limit value may correspond to a restriction on the degree of change in the torque as a function of time. In other words, once the gradient limit value has been reached, an even faster torque increase can be specifically excluded. In principle, it is conceivable to set such a gradient limit value as a fixed metric for an electric drive depending on the type. However, in the present case it is proposed that: a gradient limit value of the torque gradient of the electric drive be determined on the basis of the classified deceleration request signal. Accordingly, the gradient limit value can be dynamically set depending on the present driving situation and a specific deceleration request signal resulting therefrom. This has the advantage that a desired deceleration effect and a desired component protection can be weighed up by the control systems depending on the situation. Determining the gradient limit value may, for example, be selecting a specific gradient limit value from a plurality of predefined gradient limit values, a plurality being able to be formed by two or more gradient limit values, for example. Alternatively or additionally, a specific gradient limit value can be computed using a predetermined algorithm or computation pattern on the basis of the classified deceleration request signal. By way of example, it is also conceivable to interpolate between predefined gradient limit values in order to be able to optionally determine an individual gradient limit value.

According to an embodiment, the vehicle may include a brake controller for controlling braking functions of the vehicle, and the reception, evaluation and classification of the deceleration request signal to produce a classified deceleration request signal can be carried out via the brake controller. The brake controller may form the control unit described above or a part of the above-described control unit, which is configured to convert a deceleration request signal received at an input of the brake controller into a corresponding drive control signal. Thus, no additional control unit is required for performing the method steps and the method can be implemented using already available control components of the vehicle. The brake controller of the vehicle is usually already configured to receive a deceleration request signal, so that only the evaluation and classification of the deceleration request signal to determine a suitable gradient limit value need to be performed in order to be able to implement the method using the brake controller.

According to another configuration of the aforementioned embodiment, the vehicle can further include a drive controller for controlling the electric drive, wherein
the determination of the gradient limit value of the torque gradient of the electric drive on the basis of the classified deceleration request signal is carried out via the brake controller and/or via the drive controller; and
the actuation of the electric drive via the drive control signal to generate the negative torque according to the determined gradient limit value is carried out via the drive controller.

Therefore, according to a first variant, the gradient limit value can be determined via the brake controller and transmitted to the drive controller. The brake controller can, according to the above-described embodiment, classify the deceleration request signal, so that immediate further processing by mapping the gradient limit value to the classified deceleration request signal can be carried out in the brake controller in a technically advantageous manner. According to a second variant, the determination of the gradient limit value can be carried out in the drive controller. The drive controller may precisely store the properties of the electric drive or electric drives of the vehicle, so that the gradient limit value can be determined in the drive controller in a technically advantageous manner. According to a third variant, combining the first and second variants provides for the gradient limit value to be able to be determined in the brake controller and in the drive controller. By way of example, individual steps in determining the gradient limit value may be divided between the brake controller and the drive controller. By way of example, the brake controller and the drive controller can each determine a gradient limit value and compare the determined gradient limit values with one another and/or combine them to produce a common gradient limit value in order to be able to determine the gradient limit value reliably and/or precisely.

The drive controller and the brake controller can together form a control unit of the vehicle, for example the above-described control unit. The drive controller and the brake controller may be connected to one another, for example by wire or wirelessly, for signaling purposes, in order, for example, to be able to transmit a classified deceleration request signal and/or a gradient limit value from the brake controller to the drive controller. In principle, according to other embodiments, it is also conceivable, for example, to carry out the method exclusively via the drive controller or exclusively via the brake controller. In addition, it is possible for, by way of example, signals from sensors or predictive information from further controllers of the vehicle to be incorporated in the evaluation and classification of the deceleration request signal. By way of example, the vehicle may include vehicle surroundings sensors, the sensor signals of which are evaluated with regard to a dangerous situation for the vehicle via a further controller and can contribute, on that basis, to a classification of the deceleration request signal, for example by virtue of an evaluation result being transmitted to the brake controller and/or to the drive controller. The evaluation result can, for example, contribute to a plausibility check on the classified deceleration request signal or to the classification directly.

According to an embodiment, the evaluation and classification of the deceleration request signal to produce a classified deceleration request signal can involve ascertaining whether there is a potential emergency braking situation. This provides a defined decision basis for determining a gradient limit value that allows prioritization of the deceleration effect via the generated negative torque on the wheel of the vehicle axle, for example compared to a component protection of the electric drive. For example, an emergency braking situation may be a driving situation in which maximum deceleration is desired, for example to avoid a probable collision. By way of example, a binary classification can be carried out according to which either there is a potential emergency braking situation or there is no potential emergency braking situation, or according to which the classification result is either there is an emergency braking situation or there is no emergency braking situation. In this case, “no potential emergency braking situation” or “no emergency braking situation” can be understood to mean, for example, a normal braking situation in which no increase or maximization of the deceleration effect is required above a level of a standard deceleration effect that is customary during normal operation. With a binary classification, the method can be implemented very easily, as only a classification according to two states is carried out and the classified state can be taken as a basis for selecting between two gradient limit values, for example. In particular, a binary classification of this kind can, in principle, with the exception of rarer emergency situations, be used to make a limit value selection according to component loading aspects. By way of example, there may be provision for only a potential emergency braking situation to result in a separate gradient limit value, which differs from a standard gradient limit value intended for normal operation, being determined. For instance, the above-described drive controller may thus store a standard gradient limit value of this kind and a potential emergency braking situation may result in the above-described brake controller specifying a differing gradient limit value or transmitting a request for determining a differing gradient limit value to the drive controller. It is also conceivable to define further classification results relating to a potential emergency braking situation, for example according to the states “no emergency braking situation”, “emergency braking situation with potential damage to property” or “emergency braking situation with potential personal injury”. This allows a differentiated classification to be carried out and the intended deceleration effect can be weighted differently compared to a component protection.

According to an embodiment, the evaluation and classification of the deceleration request signal to produce a classified deceleration request signal can be carried out according to danger levels with different hazard potential values. This allows improved fine tuning of the required deceleration effect and a reduction of the component load. Classification of the deceleration request signal according to danger levels with different hazard potential values allows individual optimization of the torque delivery and a differentiated situation-appropriate vehicle response to be made possible. The hazard potential value can, according to one configuration, be a risk metric that, for example, can incorporate a percentage probability of an accident occurring and/or a probable extent of damage and can be computed and signaled as a representative indicator, for example. A classification of the deceleration request signal according to danger levels with different hazard potential values allows gradual classification of the deceleration request signal, the properties of which can indicate a driving situation with different hazard levels. According to a simplified example, in which a classification can be carried out according to a probable collision risk for the vehicle, the danger levels could be, for example:
no collision risk, for example in the event of a braking request due to a speed-restricted road section being reached;
low collision risk, for example in the event of a braking request due to the end of a queue being visible in the distance;
medium collision risk, for example in the event of a braking request due to the end of a queue after a curve; and/or
high collision risk, for example in the event of a braking request due to an accident situation directly in front of the vehicle.

According to other examples, the danger levels can, for example, also relate to different categories of
vehicle defects, such as engine malfunctions or lighting defects,
vehicle surroundings, such as urban traffic or freeway, or
road conditions, such as uneven, wet or icy surfaces.

In addition, it is conceivable to further subdivide the emergency braking situation already outlined into different danger levels, for example after probable damage to property or personal injury.

According to an embodiment, the classified deceleration request signal can be taken as a basis for determining the gradient limit value in such a way that the gradient limit value is configured to ensure or increase a minimum service life of drive components of the electric drive. This means that, depending on the situation, a component-friendly deceleration effect can be produced in order to extend the attainable operating time of the drive components of the electric drive. For example, a minimum service life may initially be a predetermined operating time of a drive component, an increase in the minimum service life being able to be regarded, in a generalized manner, as an increase in the service life of the drive component beyond the minimum service life. By way of example, a classified deceleration request signal representing a low danger level or no emergency braking situation can result in component-optimized stronger limitation of the torque gradient being carried out compared to deceleration-optimized weaker, less limiting limitation of the torque gradient. In other words, the gradient limit value to ensure or increase the minimum service life of the drive components may be lower than a gradient limit value to increase a deceleration effect, as outlined below. A lower gradient limit value allows lower degrees of change in the torque as a function of time, so that, in simple terms, a gradient limit value to ensure or increase the minimum service life of the drive components allows slower changes in the torque than a gradient limit value to increase a deceleration effect. The drive components of the electric drive whose minimum service life can advantageously be ensured or increased with a low gradient limit value may be, for example, shaft bearings in the motor and/or gears, wheel sets with tooth systems and housing parts of the electric drive; in addition, unfavorable influences on the component strengths of the shafts can be avoided. Furthermore, a low gradient limit value can be used to ensure or increase the minimum service life of power semiconductors in an inverter of the electric drive. According to one example of the embodiment, a gradient limit value suitable for ensuring or increasing the minimum service life of drive components of the electric drive can be, for example, between 5 000 Nm/s and 50 000 Nm/s, for example approximately 10 000 Nm/s. According to one configuration of the embodiment, the gradient limit value can be determined in such a way that the gradient limit value is configured to maximize a service life of drive components of the electric drive. This allows optimization of the component protection to be attained within the bounds of technically possible limits.

According to an embodiment, the classified deceleration request signal can be taken as a basis for determining the gradient limit value in such a way that the gradient limit value is configured to increase a deceleration effect. This means that an appropriate deceleration reaction can be produced depending on the situation, for example in order to allow a shorter braking distance in a driving situation with an increased hazard potential. In this case, a shortened service life or potential damage to the drive components can be deliberately permitted, for example in order to be able to cope with an emergency character of the driving situation through an increased deceleration effect. By way of example, a classified deceleration request signal representing a high danger level or an emergency braking situation can result in deceleration-optimized weaker, less limiting limitation of the torque gradient being carried out compared to component-optimized stronger limitation of the torque gradient. In other words, the gradient limit value to increase the deceleration effect may be higher than the previously outlined gradient limit value to ensure or increase the minimum service life of the drive components. A higher gradient limit value allows higher degrees of change in the torque as a function of time, so that, in simple terms, a gradient limit value to increase a deceleration effect allows faster changes in the torque than a gradient limit value to ensure or increase the minimum service life of the drive components. According to one example of the embodiment, a gradient limit value suitable for ensuring or increasing the minimum service life of drive components of the electric drive can be, for example, between 150 000 Nm/s and 250 000 Nm/s, in particular approximately 200 000 Nm/s. According to one configuration of the embodiment, the gradient limit value can be determined in such a way that the gradient limit value is configured to maximize the deceleration effect. This allows optimization of the deceleration effect to be attained within the bounds of technically possible limits, for example up to a maximum load capacity of the drive components of the electric drive. Suitable gradient limit values for maximizing the deceleration effect can be ascertained, for example, via load tests.

According to an embodiment, the classified deceleration request signal can be taken as a basis for determining the gradient limit value in such a way that the gradient limit value is between a gradient limit value for ensuring or increasing a minimum service life of drive components of the electric drive and a gradient limit value for increasing the deceleration effect. In particular, the gradient limit value may be between a gradient limit value for maximizing the service life of drive components of the electric drive and a gradient limit value for maximizing the deceleration effect. Accordingly, gradient limit values between two defined gradient limit values can also be determined, for example selected or computed. This allows improved fine tuning of the required deceleration effect and the reduction of the component load. In addition, individual optimization of the torque delivery and a differentiated situation-appropriate vehicle response can be made possible. The gradient limit value between the gradient limit value for ensuring or increasing the minimum service life of drive components of the electric drive and the gradient limit value for increasing the deceleration effect can be determined, for example, in response to a gradually classified deceleration request signal, for example can be selected on the basis of classified danger levels with different hazard potential values. In addition, the gradient limit value can be computed as an intermediate value, for example according to predetermined criteria or via interpolation between two predefined gradient limit values.

According to an embodiment, the evaluation and classification of the deceleration request signal to produce a classified deceleration request signal can incorporate a brake pedal signal, an accelerator pedal signal, a driver monitoring signal and/or vehicle state information. This enables a differentiated evaluation of the deceleration request signal and a precise, reliable classification. The signals and information may be, for example, triggers, influencing factors and/or indicators of a deceleration requirement or deceleration request. One of the signals or one of the pieces of information can be incorporated, for example, via comparison with reference signals or information, by specifying defined conditions with regard to the signals or information for classification or via incorporation into predetermined computation methods. A deceleration request can be indicated, for example, by relief of load from the accelerator pedal and/or by application of load to the brake pedal and can be detected on the basis of the changes in accelerator pedal and brake pedal signal associated with the relief or application of load, an instantaneous or dynamic form of the brake pedal signal and/or of the accelerator pedal signal being able to be incorporated into the evaluation and classification of the deceleration request signal. A driver monitoring signal can be generated, for example, via a sensor-based driver monitoring system that is configured, for example, to detect a critical driver state, for instance due to an unexpectedly occurring impairment of the health of the driver, and for this purpose may include, for example, an optical monitoring unit with connected image processing. The driver monitoring signal can be used, for example, to report a potential emergency braking situation or a danger level with a high hazard potential value and to classify the deceleration request signal accordingly. Vehicle state information can be generated, for example, via a sensor-based and/or predictive vehicle monitoring system that is configured, for example, to detect a critical vehicle state, for instance due to an occurring vehicle defect, or to carry out predictive collision detection or trajectory prediction. Vehicle state information may also relate to an instantaneous vehicle property such as a total mass or speed of travel of the vehicle, which is known to a control unit for carrying out the method or can be signaled. The vehicle state information can be used, for example, to report a potential emergency braking situation or a danger level with a high hazard potential value and to classify the deceleration request signal accordingly. The brake pedal signal, the accelerator pedal signal, the driver monitoring signal and/or the vehicle state information can also be evaluated together in combination or in sub-combinations with one another to provide a classified deceleration request signal. By way of example, it is also conceivable to carry out a plausibility check on a classified deceleration request signal via one or more of the aforementioned signals or via one or more of the aforementioned pieces of information in order to increase the reliability of the classification. In this case, it is possible for a determined classification of the deceleration request signal to result in further sensor data of the driver monitoring or vehicle monitoring system being specifically queried in order to verify the classification result or support it with further indications of a particular vehicle situation.

According to an embodiment, the evaluation and classification of the deceleration request signal to produce a classified deceleration request signal can be carried out via a signal characteristic of the brake pedal signal and/or on the basis of a signal characteristic of the accelerator pedal signal. This allows the evaluation and classification of the deceleration request signal to be implemented in a simple manner, with, for example, an emergency braking situation or different danger levels being able to be reliably detected on the basis of the signal characteristic or signal characteristics. A signal characteristic can, for example, correspond to a characteristic of the accelerator pedal signal as a function of time or to a characteristic of the brake pedal signal as a function of time, the two signal characteristics for the evaluation and classification as a function of time also being able to be considered in combination on the basis of one another. Particular characteristics or patterns of the signal characteristic or signal characteristics for the evaluation and classification can be considered, for example gradients, extremes or inflection points. By way of example, a negative gradient of the accelerator pedal signal and/or a positive gradient of the brake pedal signal can be detected and assessed, the gradient being able to define a rate of change of the signal strength as a function of time. If the signal characteristics are evaluated collectively, a changeover time between relief of load from the accelerator pedal and application of load to the brake pedal can also be taken into account for the evaluation, for example. In principle, it is conceivable for instantaneous absolute values of the brake pedal signal and/or the accelerator pedal signal to be alternatively or additionally taken into account. However, a time-dependent signal characteristic or a relative signal change as a function of time can be more meaningful and thus advantageous for a differentiated classification of the deceleration request signal.

According to an embodiment, the classified deceleration request signal can be taken as a basis for actuating a friction braking system of the vehicle in addition to the actuation of the electric drive of the wheel of the vehicle axle via the drive control signal. This allows an additional deceleration effect via the friction braking system of the vehicle to be attained. In addition, individual coordination of the torque generation via the electric drive and the friction braking system of the vehicle, for example individual distribution of the deceleration request to optimize the deceleration effect, can be made possible. By way of example, individual actuation of the electric drive and the friction braking system on the basis of the classified deceleration request signal can be carried out in such a way that the minimum service life of the drive components of the electric drive and/or the minimum service life of the brake components of the friction braking system are ensured or increased, or in such a way that a maximum deceleration effect is attained by increasing the gradient limit value and utilizing the electric drive to the maximum and by utilizing the friction braking system to the maximum. By way of example, the above-described control unit may be configured to provide the drive control signal and to actuate the friction braking system, the control unit advantageously being able to be formed by the above-described brake controller, which is configured to control brake functions of the vehicle, or being able to include the above-described brake controller. The above-described signals and information relating to a brake pedal signal, an accelerator pedal signal, a driver monitoring signal and/or vehicle state information can advantageously be used not only for evaluating and classifying the deceleration request signal, but also, for example, for determining a suitable control scheme for coordinated actuation of the electric drive and the friction braking system. By way of example, a state of the friction braking system of the vehicle can be taken into account when determining the control scheme. By way of example, to achieve a high or maximized deceleration effect, for instance, a higher load can be placed on the electric drive with a high gradient limit value if for example the friction braking system is operated with unactivated friction pairs, for example after long downtimes, and the friction brake has thus not yet been sufficiently conditioned.

The disclosure also relates to a control unit for a vehicle for carrying out the method according to one of the above-described features, the control unit being configured to receive and evaluate a deceleration request signal and to classify the deceleration request signal to produce a classified deceleration request signal, to take the classified deceleration request signal as a basis for determining a gradient limit value of a torque gradient of the electric drive and to provide a drive control signal for the electric drive to generate a negative torque according to the determined gradient limit value on a wheel of a vehicle axle. Such a control unit can also be used to attain the above-described advantages of situation-appropriate customization of a torque generation on the wheel of the vehicle axle and a deceleration effect that is better aligned with a present driving situation. The control unit may, for example, be configured to generate a drive control signal, the control unit being able to convert acceleration request signals or deceleration request signals received at an input of the control unit into a corresponding drive control signal. If the vehicle has multiple electric drives for the wheels of the vehicle axles, the control unit may be configured to coordinate the drive control signals of the multiple electric drives with one another in such a way that an aligned acceleration or deceleration effect is provided. The control unit may be configured to receive a deceleration request signal, for example may be connected for signaling purposes to a vehicle system that is configured to generate a deceleration request signal, for example to an accelerator pedal system, a brake pedal system, a driver monitoring system and/or a vehicle monitoring system. The control unit may be configured to evaluate and classify the deceleration request signal on the basis of signal properties and/or on the basis of signal characteristics. The control unit may, for example, be configured to incorporate a brake pedal signal, an accelerator pedal signal, a driver monitoring signal and/or vehicle state information into the evaluation and classification of the deceleration request signal. The control unit may, according to an embodiment, be formed by a single controller, for example by a brake controller.

According to other embodiments, it is conceivable for the control unit to include multiple controllers, for example two or more controllers. By way of example, the control unit may include a brake controller and a drive controller. The brake controller and the drive controller may be connected to one another for signaling purposes.

Furthermore, the control unit may include further controllers or be connected for signaling purposes to further controllers that, for example, allow hazard potential values of driving situations to be ascertained by sensor or prediction, so that the deceleration request signal can be evaluated and classified according to danger levels with different hazard potential values.

The disclosure also relates to a vehicle, in particular a commercial vehicle, for carrying out the method according to one of the above-described features, the vehicle including an electric drive configured to generate a torque on a wheel of a vehicle axle of the vehicle, a device for generating a deceleration request signal and a control unit according to one of the above-described features. A device for generating a deceleration request signal may, for example, be an accelerator pedal system, a brake pedal system, a driver monitoring system and/or a vehicle monitoring system. Such a vehicle can also be used to attain the above-described advantages of situation-appropriate customization of a torque generation on the wheel of the vehicle axle and a deceleration effect that is better aligned with a present driving situation. The advantages can develop a high optimization potential, in particular for commercial vehicles, since commercial vehicles can often have a higher total mass and thus a higher load on vehicle components compared to passenger vehicles and it may therefore be all the more advantageous to be able to dynamically and flexibly prioritize an increased service life of the drive components of the vehicle or a high deceleration effect.

According to an embodiment, the vehicle may include more than one vehicle axle having a wheel that can be driven via the electric drive. By way of example, the vehicle may include two or more vehicle axles including a wheel than can be driven via the electric drive. The electric drive may, for example, be in the form of a central drive for wheels on two or more vehicle axles. In principle, however, it is also conceivable for the electric drive to be in the form of a single-wheel drive or to provide a common electric drive for the wheels of a vehicle axle. The electric drive may be configured to be able to generate positive torques and negative torques on the at least one wheel according to a drive control signal, an acceleration effect being attainable by a positive torque and a deceleration effect being attainable by a negative torque.

According to an embodiment, the vehicle may be in the form of a towing vehicle, in the form of a trailer vehicle or in the form of a vehicle combination including a towing vehicle and a trailer vehicle. In this case, the towing vehicle and/or the trailer vehicle may include an electric drive configured to generate a torque on a wheel of a vehicle axle of the vehicle. According to one advantageous configuration option, the towing vehicle and the trailer vehicle of a vehicle combination may each include an electric drive that can be actuated with a drive control signal according to the above-described features. This allows the respective deceleration effect of the towing and trailer vehicles to be aligned with one another, so that, for example, the trailer vehicle can be reliably prevented from being pushed into the towing vehicle due to a lower deceleration effect on the trailer vehicle. It is conceivable, for example, for a common drive control signal to be able to be transmitted to the electric drives of the towing vehicle and the trailer vehicle or for a respective individual drive control signal for the electric drive of the towing vehicle and for the electric drive of the trailer vehicle to be generated on the basis of the classified deceleration request signal and the determined gradient limit value, for example in order to be able to take individual account of different vehicle properties. However, it is, for example, also possible, in principle, to provide a vehicle combination including a towing vehicle that includes a different drive, for example an internal combustion engine, and a trailer vehicle that includes an electric drive, or to provide for a vehicle combination including a towing vehicle that includes an electric drive and a non-driven trailer vehicle. According to one configuration option, the trailer vehicle may be in the form of a semi-trailer and the towing vehicle may be in the form of a tractor unit.

### BRIEF DESCRIPTION OF DRAWINGS

The disclosure will now be described with reference to the drawings wherein:

FIG. 1 shows a flowchart for a method for controlling an electric drive according to an embodiment;

FIG. 2 shows an illustrative characteristic of a torque as a function of time according to two different torque gradients;

FIG. 3 shows an illustrative characteristic of an accelerator pedal signal and a brake pedal signal as a function of time according to two different driving situations;

FIG. 4 shows a control unit for a vehicle according to an embodiment;

FIG. 5 shows a vehicle including a control unit according to an embodiment; and,

FIG. 6 shows a vehicle including a control unit according to a further embodiment.

### DETAILED DESCRIPTION

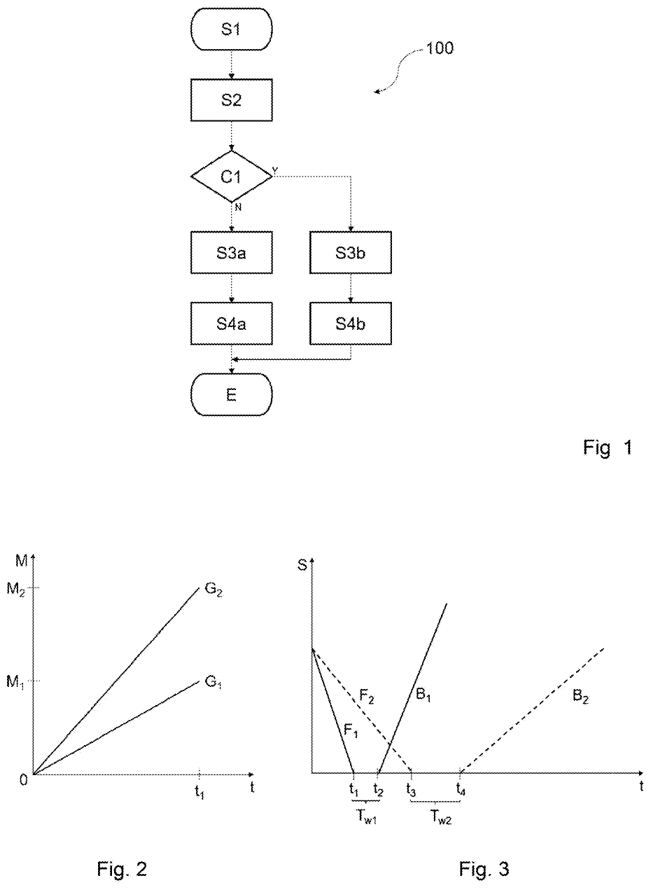

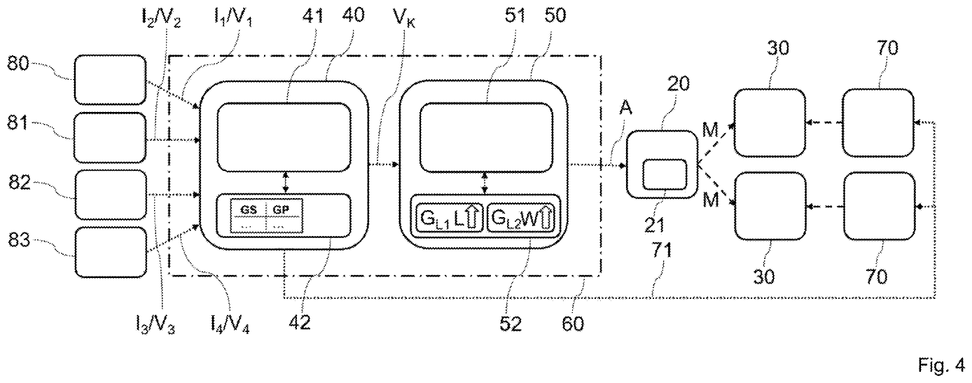

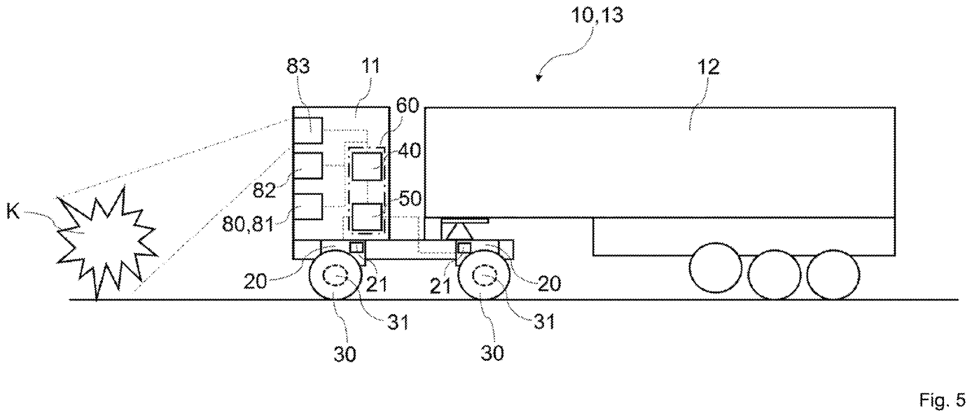

FIG. 1 shows a simplified and schematic depiction of a flowchart for a method 100 for controlling an electric drive 20 configured to generate a torque M, which is shown by way of example in FIG. 2, on a wheel 30 of a vehicle axle 31 of a vehicle 10 that is shown by way of example in FIG. 5. In a first step S1 of the method 100, a deceleration signal V₁, V₂, V₃, V₄, shown by way of example in FIG. 4, is received. In a second step S2 of the method 100, the deceleration request signal V₁, V₂, V₃, V₄ is evaluated and classified to produce a classified deceleration request signal V_{K}. Subsequently, a gradient limit value G_{L1}, G_{L2} of a torque gradient G₁, G₂ of the electric drive 20 is determined on the basis of the classified deceleration request signal V_{K} (see also FIG. 4). According to the embodiment shown in FIG. 1, there may be provision, for example, for a binary classification with the classification result “emergency braking situation” or “no emergency braking situation” as the classified deceleration request signal V_{K}. The binary classification is depicted in FIG. 1 via the condition C1 in the form of a system query, to ascertain whether there is an emergency braking situation, that leads to a third step S3b of the method 100 if the response is positive Y and leads to a third step S3a of the method 100 if the response is negative N. Step S3a of the method 100 can correspond to determination of a first gradient limit value G_{L1} and step S3b of the method 100 can correspond to determination of a second gradient limit value G_{L2}. Later on, according to a fourth step S4a or a fourth step S4b of method 100, the electric drive 20 is actuated via a drive control signal A to generate a negative torque M according to the determined gradient limit value G_{L1}, G_{L2} on the wheel 30 of the vehicle axle 31. At the end of the method E, the above-described method 100 is initially finished, but can be restarted by receipt of a further deceleration request signal V₁, V₂, V₃, V₄. The proposed method 100 can be used to attain flexible customization of a torque generation on the wheel 30 of the vehicle axle 31 of the vehicle 10 to a driving situation and a deceleration request resulting from the driving situation, so that a deceleration effect W can be optimized depending on the situation. The deceleration effect W can be influenced in favor of component-friendly slowing of the vehicle 10 or in favor of an increased braking effect of the vehicle 10, depending on the situation, for example, individual account of the two requirements being able to be taken to different extents depending on the situation. According to the embodiment in FIG. 1, a binary classification of the deceleration request signal V₁, V₂, V₃, V₄ can be carried out to produce a classified deceleration request signal V_{K}. According to other embodiments, it is also conceivable, for example, to classify the deceleration request signal V₁, V₂, V₃, V₄ according to danger levels GS with different hazard potential values GP.

FIG. 2 provides a simplified view, in linearized form, of an illustrative characteristic of a torque M as a function of time t according to two different torque gradients G₁, G₂. The torque M shown can be generated as a positive torque or as a negative torque on the wheel 30 of the vehicle axle 31 of the vehicle 10, a positive torque characteristic being shown in order to simplify the depiction in FIG. 2. A first torque gradient G₁ at a time t₁ attains a torque M₁ that is smaller than a torque M₂ attained with the second torque gradient G₂ at the same time t₁. The second torque gradient G₂ has a greater slope than the first torque gradient G₁. The second torque gradient G₂ allows a faster change in the torque M than the first torque gradient G₁. A first gradient limit value G_{L1} or second gradient limit value G_{L2} schematically indicated by way of example in FIG. 4 can form an upper limit for a torque gradient G₁, G₂ predetermined by the control systems in order to restrict a rate of change of the torque M as a function of time t. By way of example, each of the torque gradients G₁, G₂ shown in FIG. 2 can form a first gradient limit value G_{L1} and a second gradient limit value G_{L2}, so that further torque gradients permitted by the control systems can extend in an area defined between a torque gradient G₁, G₂ and the t axis. By way of example, a first gradient limit value G_{L1} may be configured to ensure or increase the minimum service life L of drive components 21 of the electric drive 20, for example shaft bearings in a motor and/or gears of the electric drive 20. By way of example, a second gradient limit value G_{L2} may be configured to increase a deceleration effect W on the vehicle 10. To that end, the second gradient limit value G_{L2} may, for example, be higher than the first gradient limit value G_{L1}, so that a higher rate of change of the torque M per time t is permitted by the control systems or requested.

FIG. 3 provides a simplified view, in linearized form, of an illustrative accelerator pedal signal characteristic F₁, F₂ of an accelerator pedal signal I₂ shown in FIG. 4 and a brake pedal signal characteristic B₁, B₂ of a brake pedal signal I₁ shown in FIG. 4 as a function of time t according to two different driving situations. The driving situation represented by a first accelerator pedal signal characteristic F₁, depicted by a solid line, and a first brake pedal signal characteristic B₁, depicted by a solid line, can correspond to an emergency braking situation, for example. The first accelerator pedal signal characteristic F₁ has a high negative slope until a zero value is reached at time t₁. The first brake pedal signal characteristic B₁ has a high slope. The period between times t₁ and t₂ corresponds to a first changeover time t_{w1} for the driver changing between relief of load from the accelerator pedal system that generates the accelerator pedal signal I₂ and application of load to the brake pedal system that generates the brake pedal signal I₁. The changeover time in an emergency braking situation can be comparatively short, so that the first changeover time T_{w1} and, for example, the slopes and other characteristic properties of the first accelerator pedal signal characteristic F₁ and the first brake pedal signal characteristic B₁ can allow detection of an emergency braking situation. By comparison, for example the driving situation represented by a second accelerator pedal signal characteristic F₂, depicted by a dashed line, and a second brake pedal signal characteristic B₂, depicted by a dashed line, can correspond to a normal braking situation, for example, which does not require emergency braking with the greatest possible deceleration effect W. The second accelerator pedal signal characteristic F₂ has a lower negative slope than the first accelerator pedal signal characteristic F₁ until a zero value is reached at time t₃. The second brake pedal signal characteristic B₂ has a lower slope than the first brake pedal signal characteristic B₁. The second changeover time T_{w2} between times t₃ and t₄ is longer than the first changeover time T_{w1} between times t₁ and t₂. Accordingly, the second changeover time T_{w2} and, for example, the slopes and other characteristic properties of the second accelerator pedal signal characteristic F₂ and the second brake pedal signal characteristic B₂ can allow detection of a normal braking situation compared to an emergency braking situation.

FIG. 4 shows a control unit 60 for a vehicle 10 according to an embodiment. The control unit 60 includes a brake controller 40 and a drive controller 50 connected for signaling purposes to the brake controller 40. The brake controller 40 is configured to control braking functions of the vehicle 10 and includes a first data processing unit 41 and a first storage unit 42 connected to the first data processing unit 41. The drive controller 50 includes a second data processing unit 51 and a second storage unit 52 connected to the second data processing unit 51. The drive controller 50 is configured to provide a drive control signal A for an electric drive 20 of the vehicle 10. The electric drive 20 is configured to generate a torque M on a wheel 30, according to the depiction in FIG. 4 on two wheels 30 of a vehicle axle 31 of the vehicle 10. The brake controller 40 is configured to receive a deceleration request signal V₁, V₂, V₃, V₄ and to evaluate and classify the deceleration request signal to produce a classified deceleration request signal V_{K}, for example via the first data processing unit 41, which can carry out the evaluation and classification for example via evaluation instructions and classification rules stored in the first storage unit 42. By way of example, the first storage unit 42 may store classification rules for danger levels GS with associated hazard potential values GP, so that the evaluation and classification of the deceleration request signal (V₁, V₂, V₃, V₄) to produce a classified deceleration request signal (V_{K}) can be carried out according to danger levels (GS) with different hazard potential values (GP). The brake controller 40 is configured, according to the embodiment shown, to transmit the classified deceleration request signal V_{K} to the drive controller 50.

The drive controller 50 is configured, according to the embodiment shown, to receive the classified deceleration request signal V_{K} from the brake controller 40 and to take the classified deceleration request signal V_{K} as a basis for determining a gradient limit value G_{L1}, G_{L2} of a torque gradient G₁, G₂ of the electric drive 20. By way of example, two different gradient limit values G_{L1}, G_{L2} of the torque gradient G₁, G₂ of the electric drive 20 may be stored in the second storage unit 52 of the drive controller 50, and the second data processing unit 51 may be configured to take the classified deceleration request signal V_{K} as a basis for selecting one of the two gradient limit values G_{L1}, G_{L2}. The actuation of the electric drive 20 via the drive control signal A can then be carried out taking into account the determined gradient limit value G_{L1}, G_{L2}, so that the generation of a torque M on the wheels 30 is carried out in such a way that the determined gradient limit value G_{L1}, G_{L2} of the torque gradient G₁, G₂ is not exceeded. By way of example, the brake controller 40 may be configured to respond to a deceleration request signal V_{K} classified as a potential emergency braking situation by selecting a second gradient limit value G_{L2} that is higher than a first gradient limit value G_{L1} in order to increase the deceleration effect W of a negative torque M delivered to the wheels 30. By way of example, the brake controller 40 may be configured to respond to a deceleration request signal V_{K} classified as a normal braking situation by selecting a first gradient limit value G_{L1} that is lower than a second gradient limit value G_{L2} in order to ensure or increase the minimum service life L of drive components 21 of the electric drive 20. By way of example, the brake controller 40 may be configured to respond to a deceleration request signal V_{K} classified as a potential emergency braking situation by selecting a second gradient limit value G_{L2} that is higher than a first gradient limit value G_{L1} in order to increase the deceleration effect W of a negative torque M delivered to the wheels 30. In principle, it is also conceivable for the second data processing unit 51 of the drive controller 50 to be configured to compute a further gradient limit value as an intermediate value between the first gradient limit value G_{L1} and the second gradient limit value G_{L2} in order to allow finer tuning and weighting of a component protection of the electric drive 20 compared to a required deceleration effect W.

The deceleration request signal V₁, V₂, V₃, V₄ can be generated, for example, by a brake pedal system 80, an accelerator pedal system 81, a driver monitoring system 82 and/or a vehicle monitoring system 83. In addition, the evaluation and classification of the deceleration request signal V₁, V₂, V₃, V₄ can incorporate, for example also additionally query or collectively evaluate, a brake pedal signal I₁, an accelerator pedal signal I₂, a driver monitoring signal I₃ and/or vehicle state information I₄. The brake controller 40 may be configured to carry out the evaluation and classification of the deceleration request signal V₁, V₂, V₃, V₄ to produce a classified deceleration request signal V_{K} on the basis of a signal characteristic B₁, B₂ of the brake pedal signal I₁ and/or on the basis of a signal characteristic F₁, F₂ of the accelerator pedal signal I₂. The brake controller 40 may be configured to provide a friction brake control signal 71 for a friction braking system 70 of the vehicle 10, in order to allow friction braking of the wheels 30, as an alternative or in addition to generating a negative torque M on the wheels 30.

FIG. 5 shows a vehicle 10 including a control unit 60 according to an embodiment. By way of illustration, the vehicle 10 is shown as a commercial vehicle and is in the form of a vehicle combination 13 including a towing vehicle 11 and a trailer vehicle 12. The towing vehicle 11 includes, according to the embodiment shown, two electric drives 20 configured to generate a torque M on one wheel 30 of each of two vehicle axles 31 of the towing vehicle 11. The control unit 60 includes a brake controller 40 and a drive controller 50. The drive controller 50 is configured to actuate the electric drives 20 via a drive control signal A. The brake controller 40 is configured to receive a deceleration request signal V₁, V₂, V₃, V₄ and, to that end, may, for example, be connected for signaling purposes to a brake pedal system 80, an accelerator pedal system 81, a driver monitoring system 82 and/or a vehicle monitoring system 83, each of which can be a suitable device for generating a deceleration request signal V₁, V₂, V₃, V₄. By way of example, the vehicle monitoring system 83 may be configured to monitor the surroundings and detect collisions involving the vehicle 10, for example in order to use optical monitoring means to detect a potential collision object K. This allows, for example, a deceleration request signal V₁, V₂ that has already been transmitted by an accelerator pedal system 81 and/or a brake pedal system 80 and a deceleration request signal V_{K} that is classified as a potential emergency braking situation to be verified or evaluated directly in connection with the brake pedal signal I₁ and/or the brake pedal signal I₂ and classified to produce a classified deceleration request signal V_{K}.

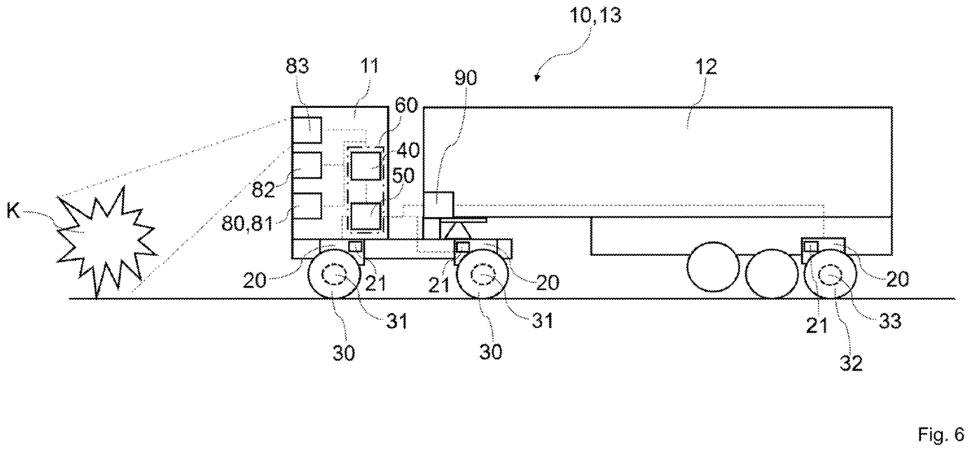

FIG. 6 shows a vehicle 10 including a control unit 60 according to a further embodiment. By way of illustration, the vehicle 10 is shown as a commercial vehicle and is in the form of a vehicle combination 13 including a towing vehicle 11 and a trailer vehicle 12. Compared to the embodiment shown in FIG. 5, not only the towing vehicle 11 but also the trailer vehicle 12 in the further embodiment shown includes an electric drive 20 configured to generate a torque M on wheels 32 of the driven vehicle axle 33 of the trailer vehicle 12. A trailer controller 90 of the trailer vehicle 12, which is connected to the drive controller 50 of the towing vehicle 11 by a signal line, can be used to transmit a drive control signal A generated via the drive controller 50 to the electric drive 20 of the trailer vehicle 12. This allows the deceleration effects of the towing vehicle 11 and the trailer vehicle 12 to be aligned with one another, for example to prevent the trailer vehicle 12 from being pushed into the towing vehicle 11. In principle, it is, according to alternative embodiments, also conceivable for only the trailer vehicle 12 to include an electric drive 20 that, by way of example, can be actuated with the drive control signal via the drive controller 50 and the trailer controller 90, while the towing vehicle 11, by way of example, is driven with a different type of drive such as an internal combustion engine.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

10 vehicle
11 towing vehicle
12 trailer vehicle
13 vehicle combination
20 electric drive
21 drive component
30 wheel of towing vehicle
31 vehicle axle of towing vehicle
32 wheel of trailer vehicle
33 vehicle axle of trailer vehicle
40 brake controller
41 first data processing unit
42 first storage unit
50 drive controller
51 second data processing unit
52 second storage unit
60 control unit
70 friction braking system
71 friction brake control signal
80 brake pedal system
81 accelerator pedal system
82 driver monitoring system
83 vehicle monitoring system
90 trailer controller
100 method for controlling an electric drive
A drive control signal
B₁ first brake pedal signal characteristic
B₂ second brake pedal signal characteristic
C1 “potential emergency braking situation” condition
E end of the method
F₁ first accelerator pedal signal characteristic
F₂ second accelerator pedal signal characteristic
G₁ first torque gradient
G₂ second torque gradient
G_{L1} first gradient limit value
G_{L2} second gradient limit value
GP hazard potential value
GS danger level
K potential collision object
L minimum service life of drive components
M torque
I₁ brake pedal signal
I₂ accelerator pedal signal
I₃ driver monitoring signal
I₄ vehicle state information
S1 receive a deceleration request signal
S2 evaluate and classify the deceleration request signal
S3a determine a first gradient limit value
S3b determine a second gradient limit value
S4a provide a first drive control signal
S4b provide a second drive control signal
t₁ first time
t₂ second time
t₃ third time
t₄ fourth time
T_{w1} first changeover time
T_{w2} second changeover time
V₁ deceleration request signal
V₂ deceleration request signal
V₃ deceleration request signal
V₄ deceleration request signal
V_{K} classified deceleration request signal
W deceleration effect

1. A method for controlling an electric drive configured to generate a torque on a wheel of a vehicle axle of a vehicle, the method comprising:
receiving a deceleration request signal;
evaluating and classifying the deceleration request signal to produce a classified deceleration request signal;
determining a gradient limit value of a torque gradient of the electric drive on a basis of the classified deceleration request signal; and,
actuating the electric drive via a drive control signal to generate a negative torque according to the determined gradient limit value on the wheel of the vehicle axle.

2. The method of claim 1, wherein the vehicle includes a brake controller for controlling braking functions of the vehicle; and, said receiving the deceleration request, and said evaluating and classifying the deceleration request signal to produce the classified deceleration request signal are carried out via the brake controller.

3. The method of claim 2, wherein:
the vehicle further includes a drive controller for controlling the electric drive;
said determining the gradient limit value of the torque gradient of the electric drive on the basis of the classified deceleration request signal is carried out via at least one of the brake controller and the drive controller; and,
said actuating the electric drive via the drive control signal to generate the negative torque according to the determined gradient limit value is carried out via the drive controller.

4. The method of claim 1, wherein said evaluating and classifying the deceleration request signal to produce the classified deceleration request signal includes ascertaining whether there is a potential emergency braking situation.

5. The method of claim 1, wherein said evaluating and classifying the deceleration request signal to produce the classified deceleration request signal is carried out according to danger levels with different hazard potential values.

6. The method of claim 1, wherein the classified deceleration request signal is taken as a basis for determining the gradient limit value such that the gradient limit value is configured to ensure or increase a minimum service life of drive components of the electric drive.

7. The method of claim 1, wherein the classified deceleration request signal is taken as a basis for determining the gradient limit value such that the gradient limit value is configured to increase a deceleration effect.

8. The method of claim 1, wherein the classified deceleration request signal is taken as a basis for determining the gradient limit value such that the gradient limit value is between a first gradient limit value for ensuring or increasing a minimum service life of drive components of the electric drive and a second gradient limit value for increasing the deceleration effect.

9. The method of claim 1, wherein said evaluating and classifying the deceleration request signal to produce the classified deceleration request signal incorporates at least one of a brake pedal signal, an accelerator pedal signal, a driver monitoring signal, and vehicle state information.

10. The method of claim 9, wherein said evaluating and classifying the deceleration request signal to produce the classified deceleration request signal is carried out on a basis of at least one of:
a signal characteristic of the brake pedal signal; and,
a signal characteristic of the accelerator pedal signal.

11. The method of claim 1, wherein the classified deceleration request signal is taken as a basis for actuating a friction braking system of the vehicle in addition to the actuation of the electric drive of the wheel of the vehicle axle via the drive control signal.

12. A control unit for a vehicle comprising:
a processor;
a non-transitory computer readable medium having program code for controlling an electric drive configured to generate a torque on a wheel of a vehicle axle of the vehicle stored thereon;
said control unit having an input configured to receive a deceleration request signal; and,
said program code being configured, when executed by said processor, to evaluate the deceleration request signal and to classify the deceleration request signal to produce a classified deceleration request signal, to take the classified deceleration request signal as a basis for determining a gradient limit value of a torque gradient of the electric drive and to provide a drive control signal for the electric drive to generate a negative torque according to the determined gradient limit value on the wheel of the vehicle axle.

13. A vehicle comprising:
a vehicle axle;
a wheel disposed on said vehicle axle;
an electric drive configured to generate a torque on said wheel;
a deceleration request signal generator configured to generate a deceleration request signal;
a control unit for controlling said electric drive;
said control unit being configured to receive a deceleration request signal; and,
said control unit being further configured to evaluate the deceleration request signal and to classify the deceleration request signal to produce the classified deceleration request signal, to take the classified deceleration request signal as a basis for determining a gradient limit value of a torque gradient of said electric drive and to provide a drive control signal for said electric drive to generate a negative torque according to the determined gradient limit value on said wheel of said vehicle axle.

14. The vehicle of claim 13, wherein the vehicle comprises a plurality of said vehicle axles each having a wheel configured to be driven via the electric drive.

15. The vehicle of claim 13, wherein the vehicle is a towing vehicle, a trailer vehicle, or a vehicle combination including a towing vehicle and a trailer vehicle.

16. The vehicle of claim 13, wherein the vehicle is a commercial vehicle.
